(19) United States
(12) Patent Application Publication
(10) Pub. No.: US 2018/0349468 A1
(43) Pub. Date: Dec. 6, 2018

(54) LOG ANALYSIS SYSTEM, LOG ANALYSIS METHOD, AND LOG ANALYSIS PROGRAM

(71) Applicant: NEC CORPORATION, Tokyo (JP)

(72) Inventor: Ryosuke TOGAWA, Tokyo (JP)

(73) Assignee: NEC CORPORATION, Tokyo (JP)

(21) Appl. No.: 15/776,922

(22) PCT Filed: Nov. 30, 2016
(86) PCT No.: PCT/JP2016/005027

§ 371 Date: May 17, 2018

(30) Foreign Application Priority Data
Nov. 30, 2015 (JP) 2015-233225

(51) Int. Cl. G06F 17/30

(52) U.S. Cl. CPC G06F 17/30598

(57) ABSTRACT

The present invention provides log analysis system, method, and program that can output information suggesting a cause of an anomaly even when a rule indicating a cause of the anomaly has not been defined. A log analysis system 100 according to one example embodiment of the present invention includes a format determination unit 120 that determines which of a plurality of predetermined forms is matched with each log included in an analysis target log; a component classification unit 130 that extracts components from each log included in the analysis target log, collects the number of occurrences of the components in the analysis target log for each of the forms, and performs classification of the components based on the number of occurrences for each of the forms; and a weighting unit 150 that performs weighting of the analysis target log based on the classification of the components.

### TECHNICAL FIELD

The present invention relates to a log analysis system, a log analysis method, and a log analysis program for performing log analysis.

### BACKGROUND ART

In general, in a system executed on a computer, logs each including a result of an event, a message, or the like are output from a plurality of devices and programs. A log analysis system detects an abnormal log from the output logs in accordance with a predetermined standard and outputs the detected log as an abnormal log to a user (operator or the like).

Since a plurality of devices and programs cooperate in a system, it may not be possible to directly identify a cause of an anomaly from a single abnormal log. In this case, a user is required to review a number of logs to search for the cause of the anomaly. In particular, it takes much time for an inexperienced user or an unknowledgeable user to identify a cause of an anomaly from the logs.

Patent Literature 1 discloses the art that registers in advance event patterns and the causes thereof or countermeasures thereto in association with each other based on past knowledge and acquires a cause of or a countermeasure to an event pattern of an input log. A use of the art of Patent Literature 1 enables a user to quickly know a cause of a registered event pattern.

### CITATION LIST

### Patent Literature

PTL 1: Japanese Patent No. 4318643

### SUMMARY OF INVENTION

However, while the art of Patent Literature 1 can acquire a cause of a registered event pattern, this art cannot acquire a cause of an unregistered event pattern. That is, since the art of Patent Literature 1 indicates a cause of an anomaly by separately predefining rules based on knowledge, this art cannot be applied to a log for which a rule indicating a cause of an anomaly has not been defined.

The present invention has been made in view of the problems described above and intends to provide a log analysis system, a log analysis method, and a log analysis program that can output information suggesting a cause of an anomaly even when a rule indicating a cause of the anomaly has not been defined.

A first example aspect of the present invention is a log analysis system including: a form determination unit that determines which of a plurality of predetermined forms is matched with each log included in an analysis target log; a component classification unit that extracts components from each log included in the analysis target log, collects the number of occurrences of the components in the analysis target log for each of the forms, and performs classification of the components based on the number of occurrences for each of the forms; and a weighting unit that performs weighting of the analysis target log based on the classification of the components.

A second example aspect of the present invention is a log analysis method including steps of: determining which of a plurality of predetermined forms is matched with each log included in an analysis target log; extracting components from each log included in the analysis target log, collecting the number of occurrences of the components in the analysis target log for each of the forms, and performing classification of the components based on the number of occurrences for each of the forms; and performing weighting of the analysis target log based on the classification of the components.

A third example aspect of the present invention is a log analysis program that causes a computer to perform steps of: determining which of a plurality of predetermined forms is matched with each log included in an analysis target log; extracting components from each log included in the analysis target log, collecting the number of occurrences of the components in the analysis target log for each of the forms, and performing classification of the components based on the number of occurrences for each of the forms; and performing weighting of the analysis target log based on the classification of the components.

According to the present invention, weighting of an analysis target log can be performed even when a rule indicating a cause of an anomaly has not been defined.

### BRIEF DESCRIPTION OF DRAWINGS

FIG. 1 is a block diagram of a log analysis system according to a first example embodiment.

FIG. 2A is a schematic diagram of an analysis target log according to the first example embodiment.

FIG. 2B is a schematic diagram of a format according to the first example embodiment.

FIG. 3A is a schematic diagram of a collection result of components according to the first example embodiment.

FIG. 3B is a schematic diagram of classification information of components according to the first example embodiment.

FIG. 3C is a schematic diagram of a weighting result of components according to the first example embodiment.

FIG. 4A is a schematic diagram of a window displaying a weighting result according to the first example embodiment.

FIG. 4B is a schematic diagram of a window displaying a weighting result according to the first example embodiment.

FIG. 5 is a general configuration diagram of the log analysis system according to the first example embodiment.

FIG. 6 is a diagram illustrating a flowchart of a component classification process using the log analysis system according to the first example embodiment.

FIG. 7 is a diagram illustrating a flowchart of an anomaly analysis process using the log analysis system according to the first example embodiment.

FIG. 8 is a block diagram of a log analysis system according to a second example embodiment.

FIG. 9 is a block diagram of a log analysis system according to a third example embodiment.

FIG. 10 is a block diagram of a log analysis system according to each example embodiment.

### DESCRIPTION OF EMBODIMENTS

While example embodiments of the present invention will be described below with reference to the drawings, the present invention is not limited to these example embodiments. Note that, in the drawings described below, those having the same function are labeled with the same reference, and the duplicated description thereof may be omitted.

### First Example Embodiment

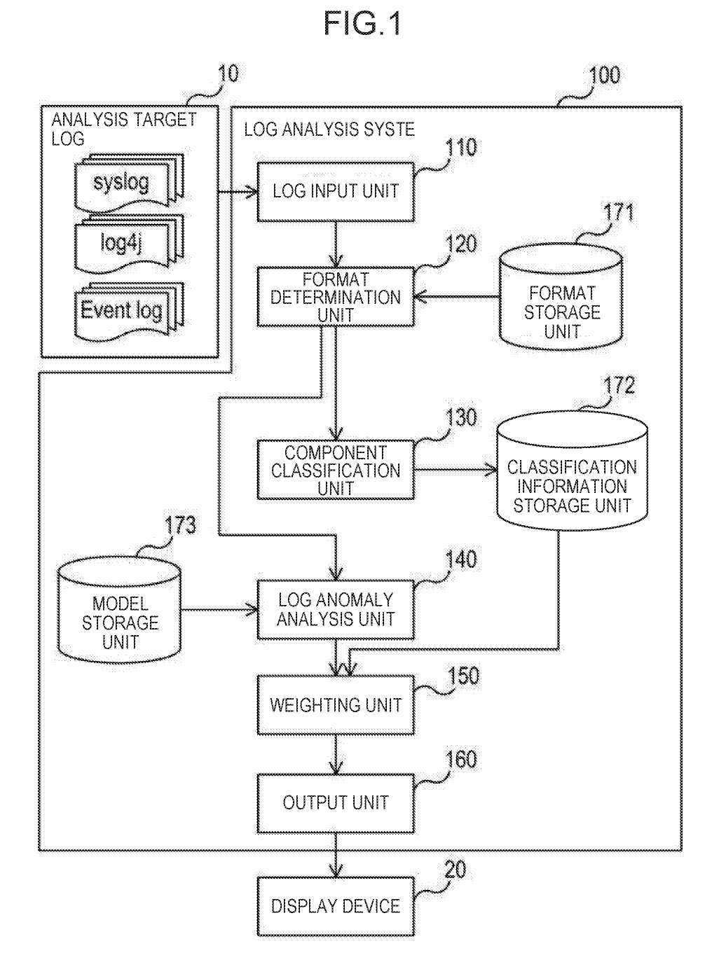

FIG. 1 is a block diagram of a log analysis system 100 according to the present example embodiment. In FIG. 1, the arrows indicate main data flows, and there may be other data flows than is illustrated in FIG. 1. In FIG. 1, each block illustrates a configuration of a function unit rather than a configuration as a unit of hardware (device). Thus, each block illustrated in FIG. 1 may be implemented within a single device or may be implemented separately in multiple devices. Data transaction among blocks may be performed via any means such as a data bus, a network, a portable storage medium, or the like.

The log analysis system 100 has a log input unit 110, a format determination unit 120, a component classification unit 130, a log anomaly analysis unit 140, a weighting unit 150, and an output unit 160 as a processing unit. Further, the log analysis system 100 has a format storage unit 171, a classification information storage unit 172, and a model storage unit 173 as a storage unit.

The log input unit 110 acquires an analysis target log 10 of an analysis target period and inputs the analysis target log 10 to the log analysis system 100. The analysis target log 10 may be acquired from the outside of the log analysis system 100 or may be acquired by reading those recorded in advance inside the log analysis system 100. The analysis target log 10 includes one or more logs output from one or more devices or programs. The analysis target log 10 is a log that is represented in any data form (file form), which may be binary data or text data, for example. Further, the analysis target log 10 may be recorded as a table of a database or may be recorded as a text file.

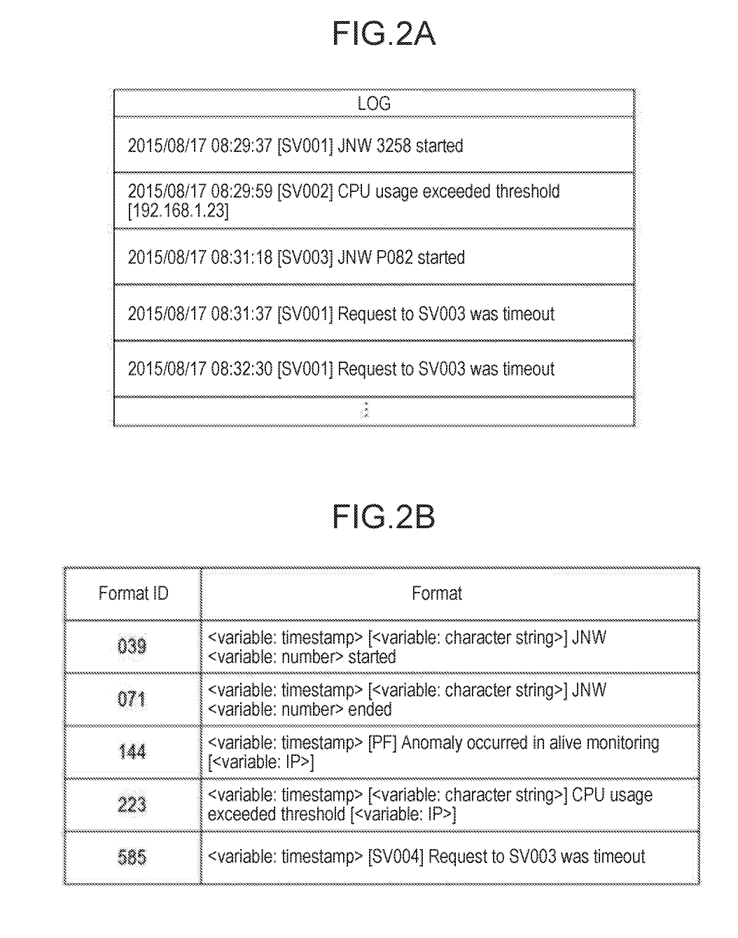

FIG. 2A is a schematic diagram of an exemplary analysis target log 10. The analysis target log 10 in the present example embodiment includes one or more any number of logs in a unit of a single log output from a device or a program. A log may be a single row of a character string or multiple rows of character strings. That is, the analysis target log 10 designates the whole logs included in the analysis target log 10, and a log denotes a single log picked out from the analysis target log 10. Each log includes a timestamp, a message, and the like. In the log analysis system 100, a broad range of types of logs can be a target of analysis without being limited to a particular type of logs. For example, logs such as a syslog, an event log, or the like that record a message output from operating system can be used as the analysis target log 10. Further, logs of a security device on a network, such as Intrusion Detection System (IDS), Intrusion Prevention System (IPS), or the like can be used as the analysis target log 10.

The format determination unit 120 is a variable extraction unit that determines which format prerecorded in the format storage unit 171 each log included in the analysis target log 10 (the first log data 11 and the second log data 12) conforms to and that uses the conforming format to separate each log into a variable part and a constant part. A format is a form of a log that is predetermined based on a log property. A log property includes such a nature that is likely or unlikely to vary among logs that are similar to each other, or such a nature that a character string which can be seen as a part that is likely to vary is described in a log. A variable part is a changeable part in a format, and a constant part is unchanging part in a format of a log. A value (including a number, a character string, and other data) of a variable part in the input log is referred to as a variable value. The variable part and the constant part are different among each format. Thus, a part defined as a variable part in a format may be defined as a constant part in another format, and vice versa. In the present example embodiment, since log analysis is performed by using a format determined based on a nature of a log as discussed above, it is possible to provide information suggesting a cause of an anomaly even with little knowledge of the event pattern, the component, or the like that is the cause of the anomaly.

FIG. 2B is a schematic diagram of an exemplary format recorded in the format storage unit 171. A format includes a character string representing a format associated with a unique ID. The format defines a variable part by describing a predetermined identifier in the changeable part of a log and defines a part other than the variable part of the log as a constant part. As an identifier of a variable part, for example, “<variable: timestamp>” indicates a variable part representing a timestamp, “<variable: character string>” indicates a variable part representing any character string, “<variable: number>” indicates a variable part representing any number, and “<variable: IP>” indicates a variable part representing any IP address. An identifier of a variable part is not limited to the above and may be defined by any method such as normalized expression, a list of possible values, or the like. Further, a format may be formed of only the constant part without including a variable part or may be formed of only the variable part without including a constant part.

For example, the format determination unit 120 determines that a log on the third row of FIG. 2A conforms to a format whose ID is 223 in FIG. 2B. The format determination unit 120 then processes the log based on the determined format and determines the timestamp “2015/08/17 08:29:59”, the character string “SV002”, and the IP address “192.168.1.23” as variable values.

While represented by a list of character strings for better visibility in FIG. 2B, a format may be represented in any data form (file form), and may be binary data or text data, for example. Further, a format may be recorded in the format storage unit 171 as a text file or may be recorded in the format storage unit 171 as a table of a database.

The component classification unit 130 extracts components included in the analysis target log 10 whose format has been determined by the format determination unit 120 and classifies the components based on similarity among these components. A component refers to a physical device such as a server, a virtual device such as a virtual machine, various programs, or the like included in a system that outputs the analysis target log 10. In the present example embodiment, log analysis is performed using a variable value indicating a component, because a cause of an anomaly is often in any of the components.

First, the component classification unit 130 extracts components from each log of the analysis target log 10 whose format has been determined by the format determination unit 120. In order to extract components, the component classification unit 130 reads a list of predefined component names and determines, as components, variable values which matches any of the list in the logs. The list of the component names may be a list of character strings indicating component names or may be a pattern such as normalized expression indicating component names.

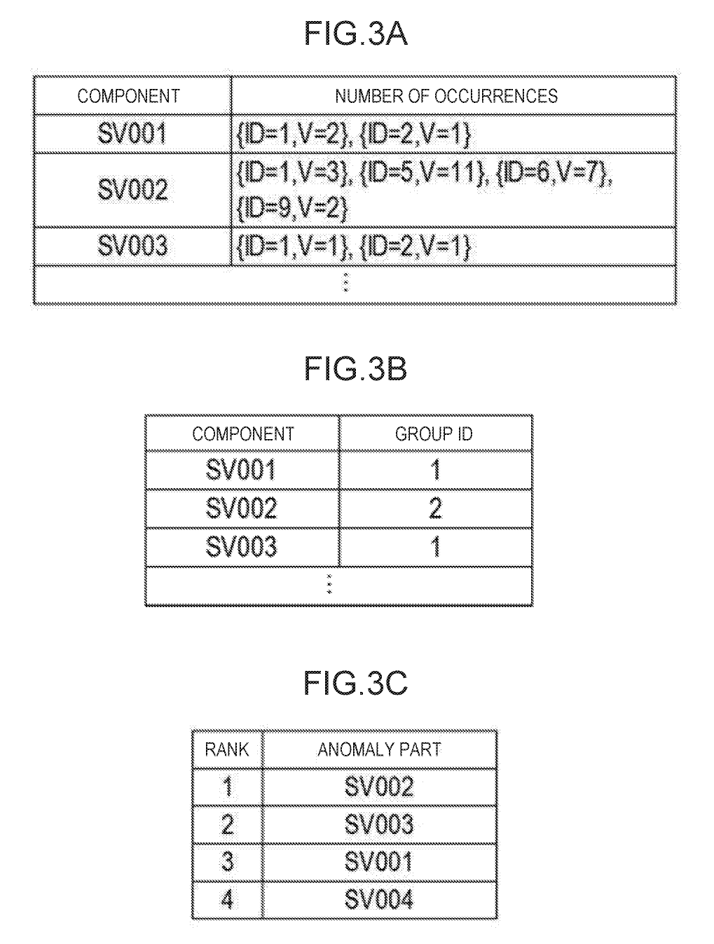

Next, for each extracted component, the component classification unit 130 collects, on a format basis, the number of logs in which the component appears, out of the analysis target log 10. FIG. 3A is a schematic diagram illustrating an exemplary collection result of the number of occurrences of the components. In FIG. 3A, description of “ID=1, V=2” for a component “SV001” means that a variable value “SV001” appears in two logs whose format ID is “1”. Accordingly, the component classification unit 130 collects and records the number of logs appearing in the analysis target log 10 on a component basis and on a format basis. Since the number of occurrences of a component is defined using the number of logs in the present example embodiment, even when the same component appears twice or more in a single log, the count is one. As another method, the number of occurrences of a component may be defined using the number of times the component appears in a log. In this case, when the same component appears twice in a single log, the count is two.

Next, the component classification unit 130 calculates a first similarity among components based on the number of format types of logs in which the component appears. The number of format types refers to the number of format IDs that appear at least once for a single component. For example, in FIG. 3A, the number of format types of the components “SV001” and “SV003” is two, and the number of format types of the component “SV002” is four. The component classification unit 130 calculates the first similarity based on the number of format types for all the combinations of two components from the extracted components. In the present example embodiment, the absolute value of the difference in the number of format types between two components is used as the first similarity. The closer the numbers of format types are, the smaller the value of the first similarity defined as above will be. Thus, the first similarity is an index as to whether or not two components are similar. The definition of the first similarity is not limited to the above, and any definition that can indicate similarity between two components in accordance with the number of format types may be used.

Further, the component classification unit 130 calculates a second similarity among components based on a composition ratio of formats of logs in which the components appear. First, the component classification unit 130 uses the number of occurrences of the collected components to calculate a composition ratio of the formats for each component. Specifically, for each component, the total log number that is a sum of the numbers of occurrences of all the formats is calculated. Then, for each component, by dividing the number of occurrences for each format by the total log number, the composition ratio for each format is calculated.

The component classification unit 130 calculates the second similarity based on the composition ratio of the formats for all the combinations of two components of the extracted components. In the present example embodiment, a distance between feature vectors generated from the composition ratio of the formats of two components is used as the second similarity. First, the component classification unit 130 generates feature vectors in which composition ratios of the formats are arranged for each component. For example, when the occurrence ratio of a format ID of 1 is 0.7, the occurrence ratio of a format ID of 2 is 0.3, and no other format appears, the feature vector will be (0.7, 0.3, 0, 0, . . . ) (the number of dimensions is equal to the number of all the formats). The component classification unit 130 then calculates the distance between feature vectors as the second similarity for all the combinations of two components of the extracted components. A method of calculating a well-known Euclid distance may be used for calculation of a distance between feature vectors. The more similar the composition ratios of formats are, the smaller the value of the second similarity will be. Thus, the second similarity is an index as to whether or not two components are similar. The definition of the second similarity is not limited to the above, and any definition that can indicate similarity between two components in accordance with the composition ratio of formats may be used.

In the present example embodiment, when the first similarity based on the number of format types is within a predetermined range and the second similarity is within a predetermined range, the component classification unit 130 determines that the two components are similar. As the predetermined range, one or more ranges of being greater than or equal to a predetermined threshold, being greater than a predetermined threshold, being less than or equal to a predetermined threshold, and being less than a predetermined threshold may be used according to the definition of the first and second similarities. While determining the similarity using both the first similarity based on the number of format types and the second similarity based on the composition ratio of formats, the component classification unit 130 according to the present example embodiment may determine the similarity by using either one of the first similarity and the second similarity.

Finally, the component classification unit 130 classifies components by classifying the components which have been determined to be similar into the same group. For example, when the components SV001 and SV002 are determined to be similar and the components SV002 and SV005 are determined to be similar, the component classification unit 130 classifies SV001, SV002, and SV005 into the same group. The component classification unit 130 records the classification result of components in the classification information storage unit 172 as classification information.

FIG. 3B is a schematic diagram illustrating exemplary classification information of components recorded in the classification information storage unit 172. Classification information includes a component and a group ID that is an identifier of a group allocated to the component. The classification information illustrated in FIG. 3B is an example and may be recorded in any form. While represented by a list of character strings for better visibility in FIG. 3B, classification information may be represented in any data form (file form), and may be binary data or text data, for example. Further, classification information may be separately recorded in a plurality of files or tables.

While classifying components based on the first similarity calculated from the number of format types and the second similarity calculated from the composition ratio of formats, the component classification unit 130 according to the present example embodiment may classify components by well-known clustering using at least one of the number of format types and the composition ratio of formats.

The log anomaly analysis unit 140 determines whether or not the log whose format has been determined by the format determination unit 120 is abnormal based on a model prerecorded in the model storage unit 173. A model is a definition of normal behavior of a log. One or more models are prerecorded in the model storage unit 173. The model means that the variable values of a number is within a predetermined range in a format, that the variable value of a character string has been registered in a format, or the like, for example. A model is not limited to the above and may be of any definition.

When an input log does not conform to any of the models in the model storage unit 173, the log anomaly analysis unit 140 determines that the log is abnormal and inputs it as an abnormal log to the subsequent weighting unit 150. On the other hand, when an input log conforms to any of the models in the model storage unit 173, the log anomaly analysis unit 140 determines that the log is a normal log and does not input it to the weighting unit 150.

The weighting unit 150 weights an abnormal log output from the log anomaly analysis unit 140 based on the classification information of components recorded in the classification information storage unit 172. Specifically, with respect to a component included in an abnormal log (referred to as an abnormal component), the weighting unit 150 acquires a component similar thereto (referred to as a similar component) from classification information recorded in the classification information storage unit 172. The weighting unit 150 extracts, from abnormal logs output from the log anomaly analysis unit 140, the same type of an abnormal log as an abnormal log in which the abnormal component is included and determines whether or not a similar component is included therein. Note that the same type of abnormal log means that abnormal logs have the same format or include the same format and the same variable value. Whether or not logs are the same type of abnormal log may be determined based on the similarity between the abnormal logs without limited to the above.

The weighting unit 150 performs weighting so as to give a lower priority to the abnormal log and the abnormal component when a similar component is included in the same type of abnormal log as the abnormal log including the abnormal component and give a higher priority to the abnormal log and the abnormal component when a similar component is not included. A priority is a value that suggests to a user that a higher priority corresponds to a higher likelihood of being a cause of an anomaly. When there are multiple similar components for a single abnormal component, the weighting unit 150 performs weighting so as to give a lower priority to the abnormal log and the abnormal component for the larger number of similar components included in the same type of abnormal log as the abnormal log including the abnormal component and give a higher priority to the abnormal log and the abnormal component for the smaller number thereof. In other words, when two components of the same classification are included in the same type of abnormal log, the weighting unit 150 performs weighting so as to decrease the priority of these two components. The weighting unit 150 sets each component included in the abnormal log output from the log anomaly analysis unit 140 to an abnormal component and repeats this weighting.

FIG. 3C is a schematic diagram illustrating an exemplary weighting result performed by the weighting unit 150. The weighting result includes the rank based on a priority caused by weighting and an anomaly part that is a component included in an abnormal log. A lower rank indicates a higher priority in weighting. While represented by a list of character strings and numbers for better visibility in FIG. 3C, a weighting result may be represented in any data form (file form), and may be binary data or text data, for example.

The output unit 160 outputs a weighting result performed by the weighting unit 150. In the present example embodiment, the output unit 160 outputs a weighting result on a display device 20, and the display device 20 displays the weighting result as an image to a user. The display device 20 has a display unit such as a liquid crystal display, a cathode ray tube (CRT) display, or the like used for displaying an image.

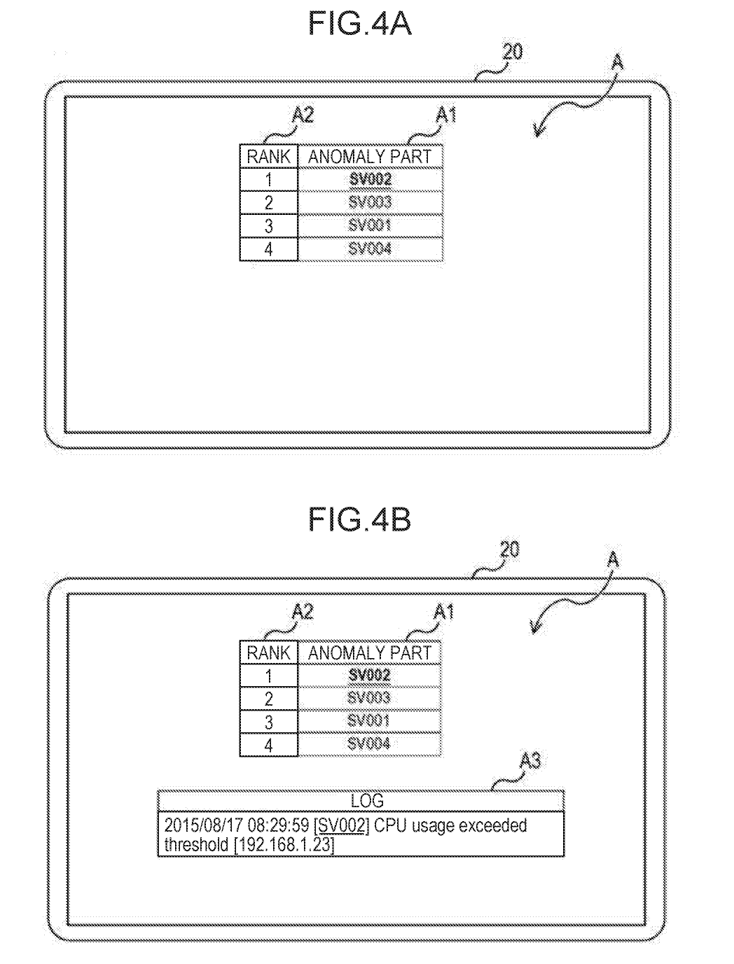

FIG. 4A and FIG. 4B are schematic diagrams illustrating a display window of an exemplary weighting result using the display device 20. Each window A illustrated in FIG. 4A and FIG. 4B displays an anomaly part A1 that is a component included in an abnormal log and a rank A2 indicating a priority in weighting. The anomaly part A1 is arranged in descending order of the rank A2 from the top to the bottom. The anomaly part A1 of the lowest rank, that is, the highest priority is highlighted in bold characters and with an underline. Furthermore, when any of the anomaly part A1 is selected by an operation using an input device such as a mouse, a touch panel, or the like (that is, an external operation), the window A displays an abnormal log A3 including the anomaly part A1 selected as illustrated in FIG. 4B. In the abnormal log A3, a character string indicating the selected anomaly part A1 is highlighted in bold characters and with an underline. By referring to the windows of FIG. 4A and FIG. 4B, the user can know a component having a high likelihood of being a cause of an anomaly in the analysis target log 10. The anomaly part A1 may be highlighted by any scheme such as a change of color or character type, blinking of characters, or the like.

The windows illustrated in FIG. 4A and FIG. 4B are examples, and any display scheme may be used as long as information including a weighting result performed by the weighting unit 150 can be displayed in a visible manner to the user. Further, a scheme of outputting information by the log analysis system 100 (output unit 160) is not limited to image display to the user. For example, the output unit 160 outputs, as data, information to be output, and the log analysis system 100 or other systems may perform a recording process, a printing process, an analysis process, a statistics process, or the like on the data from the output unit 160.

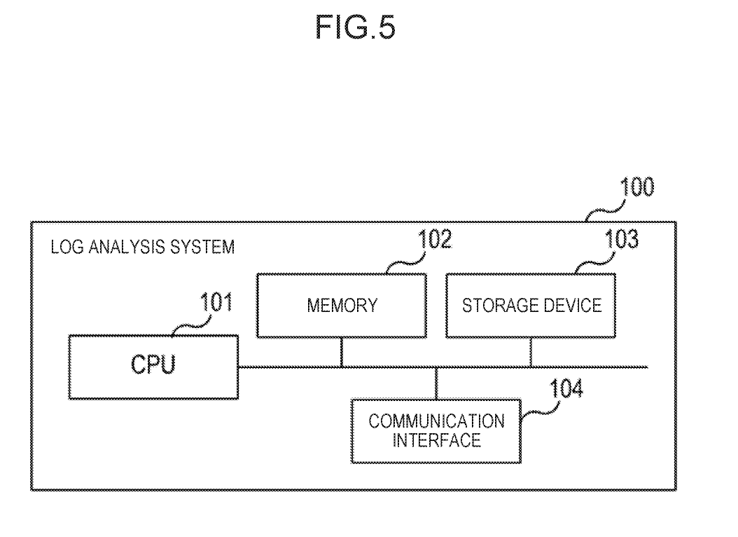

FIG. 5 is a general configuration diagram illustrating an exemplary device configuration of the log analysis system 100 according to the present example embodiment. The log analysis system 100 has a central processing unit (CPU) 101, memory 102, a storage device 103, and a communication interface 104. The log analysis system 100 may be connected to the display device 20 via the communication interface 104 or may include the display device 20. The log analysis system 100 can be a standalone device or may be integrally configured with another device.

The communication interface 104 is a communication unit that transmits and receives data and is configured to be able to perform at least one of the communication schemes of wired communication and wireless communication. The communication interface 104 includes a processor, an electric circuit, an antenna, a connection terminal, or the like required for the above communication scheme. The communication interface 104 is connected to a network using the above communication scheme in accordance with signals from the CPU 101 for communication. For example, the communication interface 104 externally receives an analysis target log 10.

The storage device 103 stores a program executed by the log analysis system 100, data resulted from processing by the program, or the like. The storage device 103 includes a read only memory (ROM) that is dedicated to reading, a hard disk drive or a flash memory that is readable and writable, or the like. Further, the storage device 103 may include a computer readable portable storage medium such as a CD-ROM. The memory 102 includes a random access memory (RAM) or the like that temporarily stores data being processed by the CPU 101 or a program and data read from the storage device 103.

The CPU 101 is a processor as a processing unit that temporarily stores transient data used for processing in the memory 102, reads a program stored in the storage device 103, and performs various processing operations such as calculation, control, determination, or the like on the transient data in accordance with the program. Further, the CPU 101 stores data of a process result in the storage device 103 and also transmits the data of the process result externally via the communication interface 104.

The CPU 101 in the present example embodiment functions as the log input unit 110, the format determination unit 120, the component classification unit 130, the log anomaly analysis unit 140, the weighting unit 150, and the output unit 160 of FIG. 1 by executing a program stored in the storage device 103. Further, the storage device 103 in the present example embodiment functions as the format storage unit 171, a classification information storage unit 172, and the model storage unit 173 of FIG. 1.

The log analysis system 100 is not limited to the specific configuration illustrated in FIG. 5. The log analysis system 100 is not limited to a single device and may be configured such that two or more physically separated devices are connected by wired or wireless connection. Respective units included in the log analysis system 100 may be implemented by electric circuitry, respectively. Electric circuitry here is a term conceptually including a single device, multiple devices, a chipset, or a cloud.

Further, at least a part of the log analysis system 100 may be provided in a form of Software as a Service (SaaS). That is, at least a part of the functions for implementing the log analysis system 100 may be performed by software executed via a network.

A log analysis method using the log analysis system 100 according to the present example embodiment is formed of a component classification process that classifies components and records classification information and an anomaly analysis process that performs weighting based on the classification information. The classification information of the component once stored in the classification information storage unit 172 by the component classification process can be repeatedly used unless a significant change occurs in the component. Thus, the component classification process and the anomaly analysis process may be performed continuously, or multiple times of the anomaly analysis processes may be performed after a single time of the component classification process.

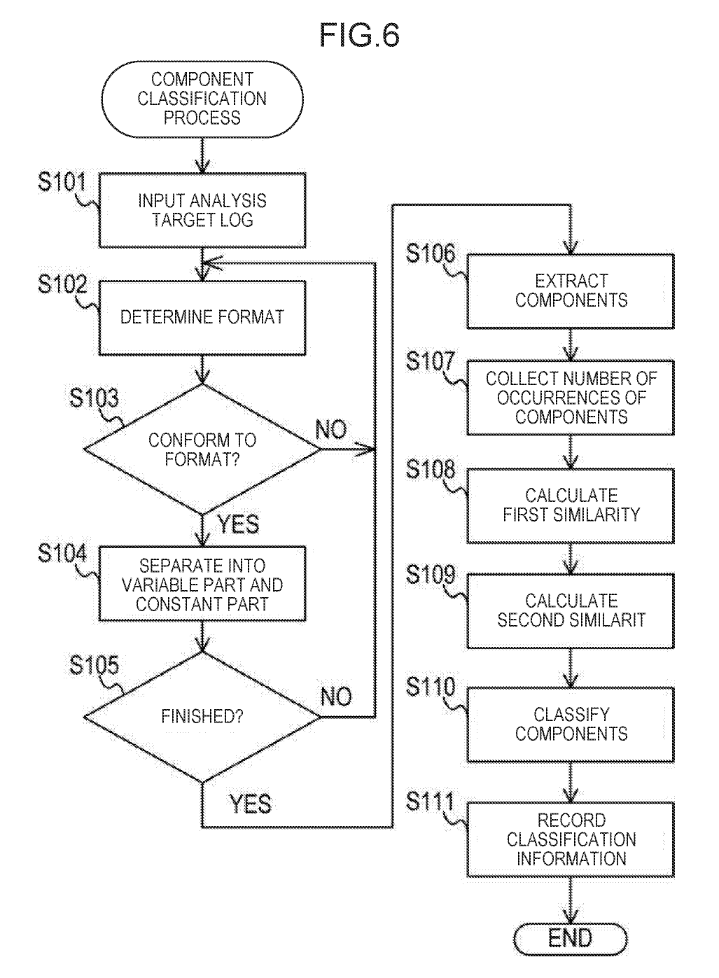

FIG. 6 is a diagram illustrating a flowchart of the component classification process according to the present example embodiment. First, the log input unit 110 acquires and inputs the analysis target log 10 to the log analysis system 100 (step S101). The format determination unit 120 designates one log to be determined included in the analysis target log 10 input in step S101 and determines whether or not the designated log conforms to any format recorded in the format storage unit 171 (step S102).

If the log to be determined does not conform to any of the formats recorded in the format storage unit 171 in step S102 (step S103, NO), the next log in the analysis target log 10 is designated as a log to be determined, and steps S102 to S103 are repeated.

If the log to be determined conforms to any format recorded in the format storage unit 171 in step S102 (step S103, YES), the format determination unit 120 uses the format to separate the log to be determined into a variable part and a constant part (step S104). The format determination unit 120 records variable values in the log to be determined.

If the format determination is not finished for all the logs in the analysis target log 10 (step S105, NO), the next log in the analysis target log 10 is designated as a log to be determined, and steps S102 to S105 are repeated.

If the format determination is finished for all the logs in the analysis target log 10 (step S105, YES), the component classification unit 130 extracts components from each log in the analysis target log 10 from which the variable part is acquired in step S104 (step S106). Next, for each format with respect to each component extracted in step S106, the component classification unit 130 collects the number of logs in which the component appears in the analysis target log 10 (step S107).

Next, the component classification unit 130 calculates the first similarity based on the number of format types for all the combinations of two components of the components extracted in step S106 (step S108). Next, the component classification unit 130 calculates the second similarity based on the composition ratio of formats for all the combinations of two components of the components extracted in step S106 (step S109). Step S108 and step S109 may be performed in the opposite order or may be performed in parallel. The calculation scheme described above with respect to the component classification unit 130 is used for calculation of the first and second similarities.

When the first similarity calculated in step S108 is within a predetermined range and the second similarity calculated in step S109 is within a predetermined range, the component classification unit 130 determines that the two components are similar. The component classification unit 130 then classifies the components by classifying the components determined to be similar into the same group (step S110). Finally, the component classification unit 130 records the resulted classified in step S110 as classification information in the classification information storage unit 172 (step S111).

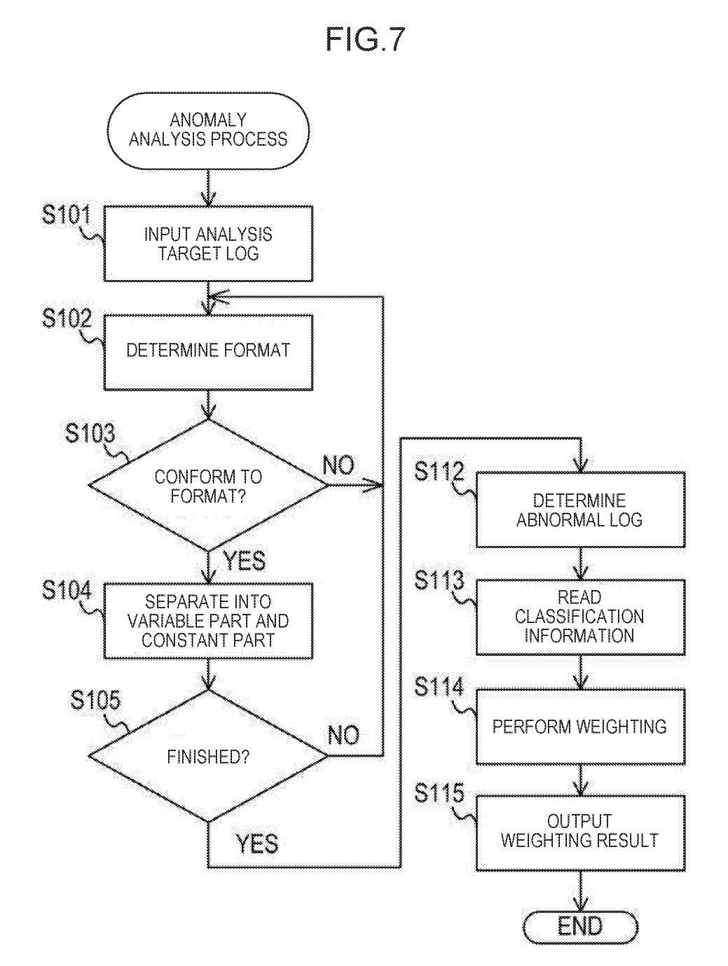

FIG. 7 is a diagram illustrating a flowchart of the anomaly analysis process according to the present example embodiment. The format determination in steps S101 to S105 is similar to the component classification process. The result of the format determination in steps S101 to S105 performed in the component classification process may be used in the anomaly analysis process, or the format determination of steps S101 to S105 may be performed again in the anomaly analysis process.

Next, the log anomaly analysis unit 140 determines whether or not each log of the analysis target log 10 whose format has been determined in step S102 is abnormal based on the models prerecorded in the model storage unit 173 (step S112). When the input log does not conform to any of the models in the model storage unit 173, the log anomaly analysis unit 140 determines that the log is abnormal and designates it as an abnormal log to be subjected to weighting in steps S113 and S114.

Next, the weighting unit 150 reads the classification information output in the component classification process from the classification information storage unit 172 (step S113). From the read classification information, the weighting unit 150 then acquires a component (similar component) similar to each component (abnormal component) included in the abnormal log acquired in step S112. Furthermore, the weighting unit 150 extracts the same type of abnormal log as the abnormal log including the abnormal component from the abnormal logs acquired in step S112 and determines whether or not a similar component is included therein. The weighting unit 150 performs weighting so as to give a lower priority to the abnormal log and the abnormal component when a similar component is included in the same type of abnormal log as the abnormal log including the abnormal component and give a higher priority to the abnormal log and the abnormal component when a similar component is not included (step S114).

After weighting is finished for the component included in all the abnormal logs acquired in step S112, the output unit 160 outputs the weighting result in step S114 on the display device 20 (step S115). The display device 20 uses a predetermined window (for example, the windows A of FIG. 4A and FIG. 4B) to display the weighting result.

In general, when similar components output the same type of anomaly log, this may often mean that these components themselves are not causing an anomaly but are merely being affected by an anomaly caused by another component. On the other hand, when a component similar to a component outputting an anomaly log does not output the same type of abnormal log as the abnormal log, this may often mean that some anomaly occurs in only the component outputting the abnormal log resulting in the anomaly. Thus, by performing weighting so as to decrease the priority when similar components output the same type of abnormal log and, otherwise, to increase the priority, the log analysis system 100 according to the present example embodiment can provide the user with information that suggests a component having a high likelihood of causing an anomaly.

### Second Example Embodiment

The first example embodiment performs weighting so as to change the priority in accordance with whether or not similar components output the same type of abnormal log in the analysis target log 10 input at a time. In contrast, the present example embodiment performs weighting so as to change the priority in accordance with whether or not similar components output the same type of abnormal logs among the currently input analysis target log 10 and abnormal logs detected in the past.

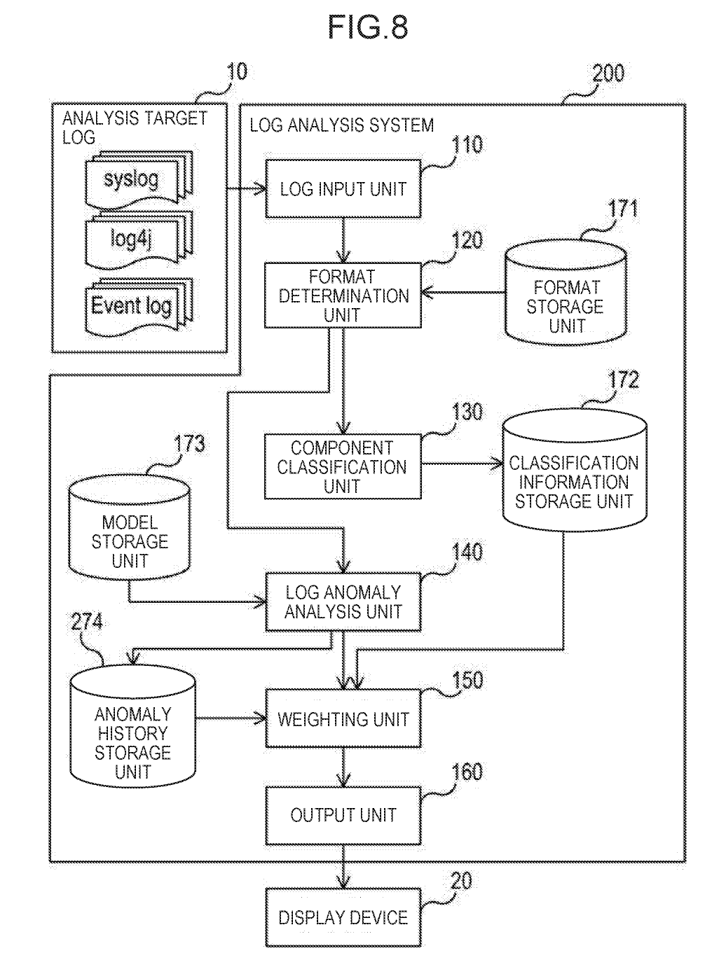

FIG. 8 is a block diagram of a log analysis system 200 according to the present example embodiment. The log analysis system 200 has an anomaly history storage unit 274 in addition to the configuration of FIG. 1. In the log analysis system 200, the functions of the log anomaly analysis unit 140 and the weighting unit 150 are different from those in the first example embodiment.

The log anomaly analysis unit 140 according to the present example embodiment determines an abnormal log in a similar manner to the first example embodiment and then accumulates the abnormal log in the anomaly history storage unit 274. The anomaly history storage unit 274 may record an identifier, the determined format, the included component, anomaly information indicating the determined anomaly, the weighted priority, action information indicating an action such as disregard, in addition to the abnormal log. The abnormal log may be recorded in the anomaly history storage unit 274 in any form such as a table in a database or text file.

The weighting unit 150 according to the present example embodiment performs weighting on the abnormal log output from the log anomaly analysis unit 140 based on classification information of components recorded in the classification information storage unit 172 and the past abnormal logs stored in the anomaly history storage unit 274. Specifically, with respect to a component included in the abnormal log acquired in the current anomaly analysis process (referred to as a current abnormal log) (referred to as an abnormal component), the weighting unit 150 acquires a component similar thereto (referred to as a similar component) from classification information recorded in the classification information storage unit 172. The weighting unit 150 then extracts, out of abnormal logs recorded before the current anomaly analysis process (referred to as past abnormal logs) in the anomaly history storage unit 274, the same type of past abnormal log as the current abnormal log including the abnormal component and determines whether or not the similar component is included therein. Note that the same type of abnormal log means that abnormal logs each have the same format or each have the same format and include the same variable value. Whether or not logs are the same type of abnormal log may be determined based on the similarity between the abnormal logs without limited to the above.

The weighting unit 150 performs weighting so as to give a lower priority to the current abnormal log and the abnormal component when a similar component is included in the same type of past abnormal log as the current abnormal log including the abnormal component and give a higher priority to the current abnormal log and the abnormal component when no similar component is included. When there are multiple similar components for a single abnormal component, the weighting unit 150 performs weighting so as to give a lower priority to the current abnormal log and the abnormal component for the larger number of similar components included in the same type of past abnormal log as the current abnormal log including the abnormal component and give a higher priority to the current abnormal log and the abnormal component for the smaller number thereof. The weighting unit 150 sets each component included in the current abnormal log output from the log anomaly analysis unit 140 to an abnormal component and repeats this weighting.

Furthermore, both weighting performed among the current abnormal logs and weighting performed among the current abnormal logs and the past abnormal logs may be performed by combining the present example embodiment and the first example embodiment.

The weighting unit 150 may perform weighting by using information associated with the past abnormal logs. The information associated with the past abnormal logs may be the content of an action to the past abnormal log, such as disregard, for example. In this case, if an action of disregard has been performed on the same type of the past abnormal log as the current abnormal log, the weighting unit 150 performs weighting so as to give a lower priority to the current abnormal log. Further, the priority weighted to the past abnormal log may be used as the information associated with the past abnormal logs.

Accordingly, in the present example embodiment, anomaly determination of the current abnormal log can be performed based on the similarity of components in the abnormal log and the past abnormal logs. For example, while the accuracy of weighting among the current abnormal logs in the first example embodiment may decrease when there are few current abnormal logs, accurate weighting can be performed even in such a case by using the accumulated past abnormal logs according to the present example embodiment.

### Third Example Embodiment

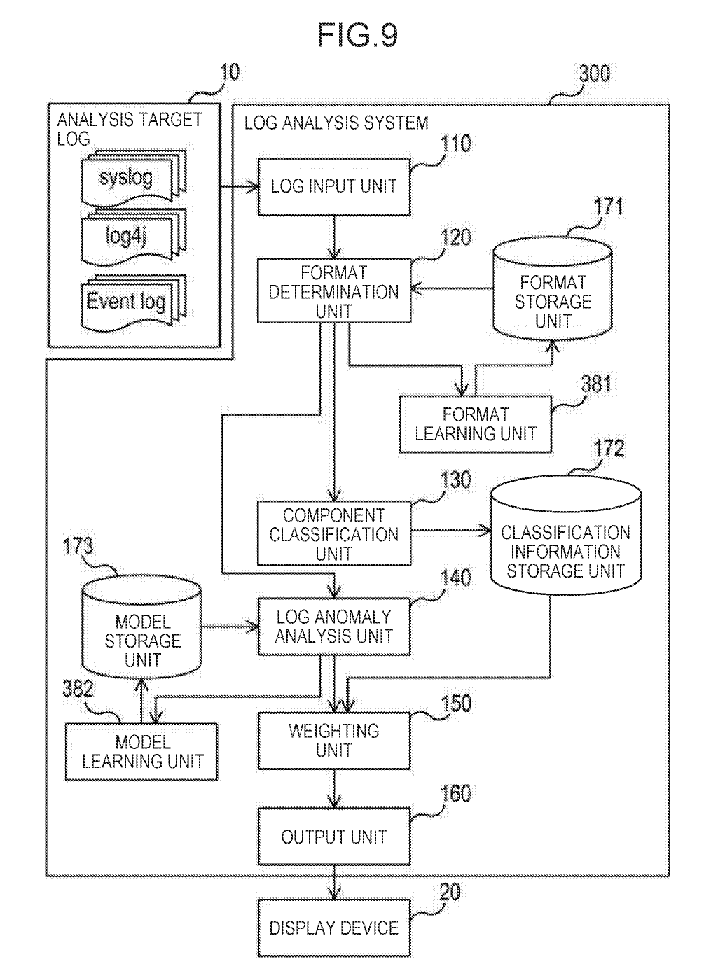

FIG. 9 is a block diagram of a log analysis system 300 according to the present example embodiment. The log analysis system 300 has a format learning unit 381 and a model learning unit 382 in addition to the configuration of FIG. 1.

When the format determination unit 120 determines the format and when a log to be determined does not conform to any of the formats recorded in the format storage unit 171, the format leaning unit 381 creates a new format and records the new format in the format storage unit 171.

As a first method for the format learning unit 381 to learn a format, the format learning unit 381 can define a new format by accumulating a plurality of logs whose formats are unknown and statistically separating the logs into changeable variable values and unchangeable constant parts. As a second method for the format learning unit 381 to learn a format, the format learning unit 381 can define a new format by reading a list of known variable values, determining, as a variable value, a part which is the same as or similar to the known variable value out of a log whose format is unknown, and determining other parts as a constant part. A value itself may be used as a known variable value, or a pattern such as normalized expression may be used. The learning method of a format is not limited to the above, and any learning algorithm that can define a new format for an input log may be used.

When the log anomaly analysis unit 140 determines the model and when a log to be determined does not conform to any of the models recorded in the model storage unit 173, the model leaning unit 382 creates a new model and records the new model in the model storage unit 173.

Typically, while the log anomaly analysis unit 140 determines a log which does not conform to any of the models prerecorded in the model storage unit 173, even when a log is of an unknown model, such a log may be a normal log. In this case, when the user inputs via an input device an instruction indicating that a log that does not conform to any model in the model storage unit 173 is a normal log, the model learning unit 382 creates a new model based on the format and the variable value of the log and records the created model in the model storage unit 173. The learning method of a model is not limited to the above, and any learning algorithm that can define a new model for an input log may be used.

As discussed above, since the log analysis system 300 has learning units for a format and a model, it is possible to newly generate and record a format and a model from a log including unknown format and model.

### Other Example Embodiments

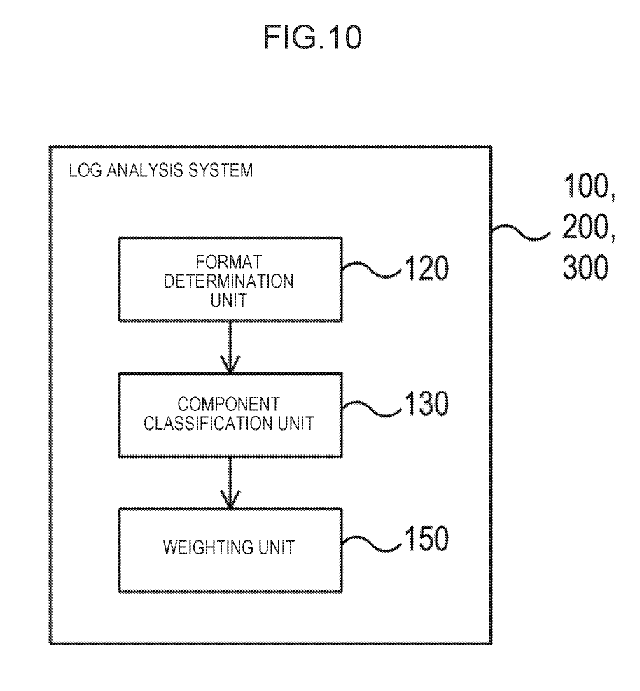

FIG. 10 is a general configuration diagram of each of the log analysis systems 100, 200, and 300 according to each of the example embodiments described above. FIG. 10 illustrates a configuration example by which each of the log analysis systems 100, 200, and 300 functions as a device that performs weighting based on classification of components. Each of the log analysis systems 100, 200, and 300 has the format determination unit 120 as a form determination unit that determines which of a plurality of predetermined forms is matched with each log included in an analysis target log, a component classification unit 130 that extracts components from each log included in the analysis target log, collects the number of occurrences of the components in the analysis target log for each of the forms, and performs classification of the components based on the number of occurrences for each of the forms, and a weighting unit 150 that performs weighting of the analysis target log based on the classification of the components.

The present invention is not limited to the example embodiments described above and can be properly changed within a scope not departing from the spirit of the present invention.

Further, the scope of each of the example embodiments includes a processing method that stores, in a storage medium, a program causing the configuration of each of the example embodiments to operate so as to realize the function of each of the example embodiments described above (more specifically, a program causing a computer to perform the process illustrated in FIG. 6 or FIG. 7), reads the program stored in the storage medium as a code, and executes the program in a computer. That is, the scope of each of the example embodiments includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

A log analysis system comprising:

a form determination unit that determines which of a plurality of predetermined forms is matched with each log included in an analysis target log;

a component classification unit that extracts components from each log included in the analysis target log, collects the number of occurrences of the components in the analysis target log for each of the forms, and performs classification of the components based on the number of occurrences for each of the forms; and

a weighting unit that performs weighting of the analysis target log based on the classification of the components.

(Supplementary Note 2)

The log analysis system according to supplementary note 1, wherein, when the component classification unit determines that two of the components are similar based on the number of occurrences for each of the forms, the component classification unit performs the classification by classifying the two components into the same group.

(Supplementary Note 3)

The log analysis system according to supplementary note 2, wherein the component classification unit calculates a first similarity based on the number of types of the forms matched with a log in which the two components appear and classifies the two components into the same group when the first similarity is within a predetermined range.

(Supplementary Note 4)

The log analysis system according to supplementary note 2, wherein the component classification unit calculates a second similarity based on a composition ratio of the forms matched with a log in which the two components appear and classifies the two components into the same group when the second similarity is within a predetermined range.

(Supplementary Note 5)

The log analysis system according to supplementary note 2, wherein the component classification unit calculates a first similarity based on the number of types of the forms matched with a log in which the two components appear, calculates a second similarity based on a composition ratio of the forms matched with a log in which the two components appear, and classifies the two components into the same group when the first similarity is within a first predetermined range and the second similarity is within a second predetermined range.

(Supplementary Note 6)

The log analysis system according to any one of supplementary notes 1 to 5 further comprising an anomaly analysis unit that determines whether or not each log included in the analysis target log is an abnormal log,

wherein the weighting unit performs the weighting on the abnormal log determined by the anomaly analysis unit.

(Supplementary Note 7)

The log analysis system according to supplementary note 6, wherein, when two of the components having the same classification are included in the same type of the anomaly log, the weighting unit performs the weighting so as to decrease a priority of the two components having the same classification.

(Supplementary Note 8)

The log analysis system according to supplementary note 6 or 7, wherein the weighting unit performs the weighting on the abnormal log determined by the abnormal analysis unit based on the abnormal log recorded in the past.

(Supplementary Note 9)

A log analysis method comprising steps of:

determining which of a plurality of predetermined forms is matched with each log included in an analysis target log;

extracting components from each log included in the analysis target log, collecting the number of occurrences of the components in the analysis target log for each of the forms, and performing classification of the components based on the number of occurrences for each of the forms; and

performing weighting of the analysis target log based on the classification of the components.

(Supplementary Note 10)

A log analysis program that causes a computer to perform steps of:

determining which of a plurality of predetermined forms is matched with each log included in an analysis target log;

extracting components from each log included in the analysis target log, collecting the number of occurrences of the components in the analysis target log for each of the forms, and performing classification of the components based on the number of occurrences for each of the forms; and

performing weighting of the analysis target log based on the classification of the components.

This application is based upon and claims the benefit of priority from Japanese Patent Application No. 2015-233225, filed on Nov. 30, 2015, the disclosure of which is incorporated herein in its entirety by reference.

1. A log analysis system comprising:
a form determination unit that determines which of a plurality of predetermined forms is matched with each log included in an analysis target log;
a component classification unit that extracts components from each log included in the analysis target log, collects the number of occurrences of the components in the analysis target log for each of the forms, and performs classification of the components based on the number of occurrences for each of the forms; and
a weighting unit that performs weighting of the analysis target log based on the classification of the components.

2. The log analysis system according to claim 1, wherein, when the component classification unit determines that two of the components are similar based on the number of occurrences for each of the forms, the component classification unit performs the classification by classifying the two components into the same group.

3. The log analysis system according to claim 2, wherein the component classification unit calculates a first similarity based on the number of types of the forms matched with a log in which the two components appear and classifies the two components into the same group when the first similarity is within a predetermined range.

4. The log analysis system according to claim 2, wherein the component classification unit calculates a second similarity based on a composition ratio of the forms matched with a log in which the two components appear and classifies the two components into the same group when the second similarity is within a predetermined range.

5. The log analysis system according to claim 2, wherein the component classification unit calculates a first similarity based on the number of types of the forms matched with a log in which the two components appear, calculates a second similarity based on a composition ratio of the forms matched with a log in which the two components appear, and classifies the two components into the same group when the first similarity is within a first predetermined range and the second similarity is within a second predetermined range.

6. The log analysis system according to claim 1 further comprising an anomaly analysis unit that determines whether or not each log included in the analysis target log is an abnormal log,
wherein the weighting unit performs the weighting on the abnormal log determined by the anomaly analysis unit.

7. The log analysis system according to claim 6, wherein, when two of the components having the same classification are included in the same type of the anomaly log, the weighting unit performs the weighting so as to decrease a priority of the two components having the same classification.

8. The log analysis system according to claim 6, wherein the weighting unit performs the weighting on the abnormal log determined by the abnormal analysis unit based on the abnormal log recorded in the past.

9. A log analysis method comprising:
determining which of a plurality of predetermined forms is matched with each log included in an analysis target log;
extracting components from each log included in the analysis target log, collecting the number of occurrences of the components in the analysis target log for each of the forms, and performing classification of the components based on the number of occurrences for each of the forms; and
performing weighting of the analysis target log based on the classification of the components.

10. A non-transitory storage medium in which a log analysis program is stored, the program causing a computer to execute:
determining which of a plurality of predetermined forms is matched with each log included in an analysis target log;
extracting components from each log included in the analysis target log, collecting the number of occurrences of the components in the analysis target log for each of the forms, and performing classification of the components based on the number of occurrences for each of the forms; and
performing weighting of the analysis target log based on the classification of the components.
